(19) United States
(12) Patent Application Publication
(10) Pub. No.: US 2019/0048936 A1
(43) Pub. Date: Feb. 14, 2019

(54) BALANCER DEVICE AND BALANCER DEVICE FOR INTERNAL COMBUSTION ENGINE

(71) Applicant: HITACHI AUTOMOTIVE SYSTEMS, LTD., Hitachinaka-shi, Ibaraki (JP)

(72) Inventor: Tamotsu TODO, Atsugi-shi, Kanagawa (JP)

(73) Assignee: HITACHI AUTOMOTIVE SYSTEMS, LTD., Hitachinaka-shi, Ibaraki (JP)

(21) Appl. No.: 16/079,075

(22) PCT Filed: Feb. 13, 2017
(86) PCT No.: PCT/JP2017/005092

§ 371 Date: Aug. 22, 2018

(30) Foreign Application Priority Data
Feb. 23, 2016 (JP) 2016-032403

(51) Int. Cl. F16C 35/077; F16C 27/06; F16F 15/26

(52) U.S. Cl. CPC F16C 35/077; F16F 15/26; F16C 27/066; F16C 27/063

(57) ABSTRACT

Provided is a balancer device in which friction loss between a driving shaft and a bearing can be reduced. The balancer device of the invention comprises an upper housing and a lower housing. The upper housing receives the upper half portion of a rolling bearing which rotatably supports the driving shaft. The balancer device includes a first member which biases the rolling bearing toward a bearing receiving portion.

### TECHNICAL FIELD

The invention relates to a balancer device used, for example, in internal combustion engines.

### BACKGROUND ART

The related art can be seen in well-known balancer devices with driving and driven shafts supported by upper and lower housings. The balancer devices each has a driving shaft that is configured as below. First and second journals are disposed at both ends of a balancer weight located on one side of the driving shaft. The first and second journals are supported by first and second driving bearings comprising upper and lower housings. A zeroth journal is formed near the other end of the driving shaft, which is constantly pulled upward by tension of a chain. The zeroth journal is supported only at the upper half portion by a zeroth driving bearing which is a slide bearing disposed only in the upper housing.

The related art is disclosed, for example, in the Patent Literature 1 mentioned below.

### CITATION LIST

### Patent Literature

TL 1: Japanese Unexamined Patent Application Publication (Kokai) No. 2009-216106

### SUMMARY OF INVENTION

### Technical Problem

Since the driving shaft of the balancer device in the related art is constantly pulled upward at the other end by the tension of the chain, the zeroth driving hearing is cantilever-supported and in contact with an area dose to the edge on the other end side of the driving shaft. A contact area between the driving shaft and the zeroth driving hearing is therefore applied with high surface pressure, possibly increasing friction loss between the driving shaft and the zeroth, driving bearing.

It is an object of the invention to provide a balancer device for an internal combustion engine, in which friction loss between a driving shaft and a bearing can be reduced.

### Solution to Problem

According to one embodiment of the invention, a balancer device includes an upper housing and a lower housing. The upper housing receives an upper half portion of a rolling bearing that rotatably supports a driving shaft. The balancer device has a first member configured to bias the rolling bearing toward a bearing receiving portion.

The one embodiment of the invention thus makes it possible to reduce rotational resistance of the driving shaft.

### BRIEF DESCRIPTION OF DRAWINGS

FIG. 1 is an exploded perspective view of a balancer device according to an Embodiment 1.

FIG. 2 is a plan view of the balancer device according to the Embodiment 1.

FIG. 3 is a cross-sectional view taken along line A-A of FIG. 2.

FIG. 4 is an enlarged perspective view showing a first boss and its vicinity according to the Embodiment 1.

FIG. 5 is a side view of the balancer device according to the Embodiment 1.

FIG. 6 is a schematic diagram showing relationship between a driving chain and the balancer device according to the Embodiment 1.

FIG. 7 shows a deformed state of the driving balancer shaft being pulled up toward an engine.

FIG. 8 shows a side view and a cross-sectional view of a balancer device according to an Embodiment 2, taken along line B-B.

FIG. 9 shows a side view and a cross-sectional view of a balancer device according to an Embodiment 3, taken along line B-B.

FIG. 10 shows cross-sectional views of a balancer device according to an Embodiment 4, taken along lines C-C and B-B.

FIG. 11 shows cross-sectional views of a balancer device according to an Embodiment 5, taken along lines C-C and B-B.

FIG. 12 is a side view of a balancer device according to an Embodiment 6.

### DESCRIPTION OF EMBODIMENTS

### Embodiment 1

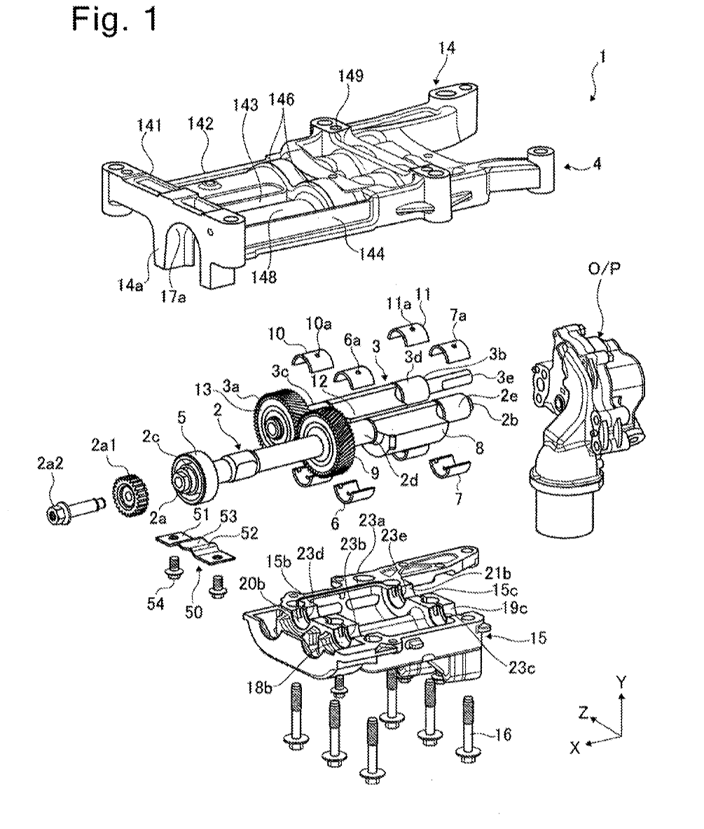

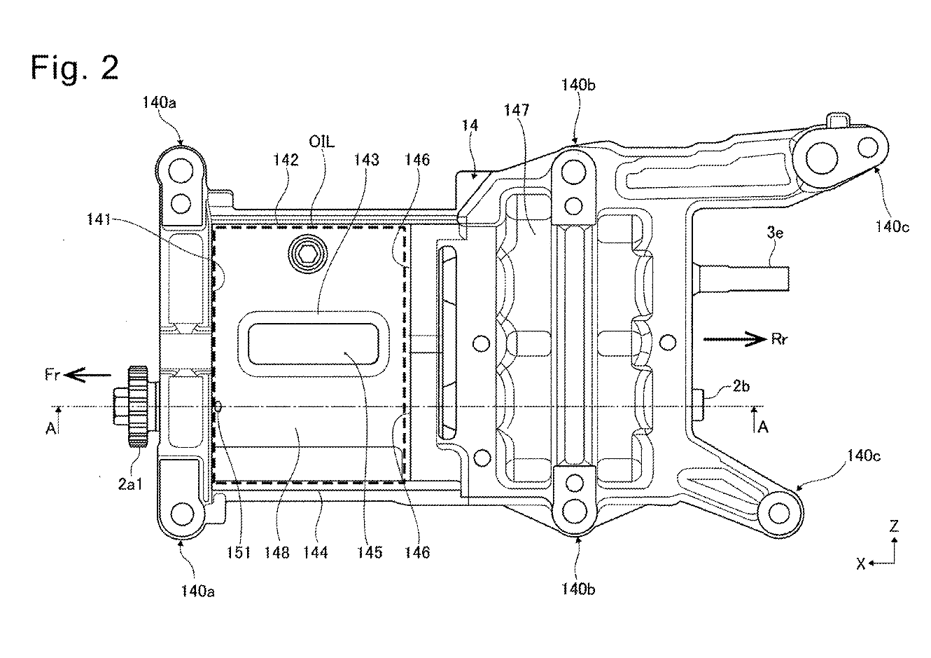

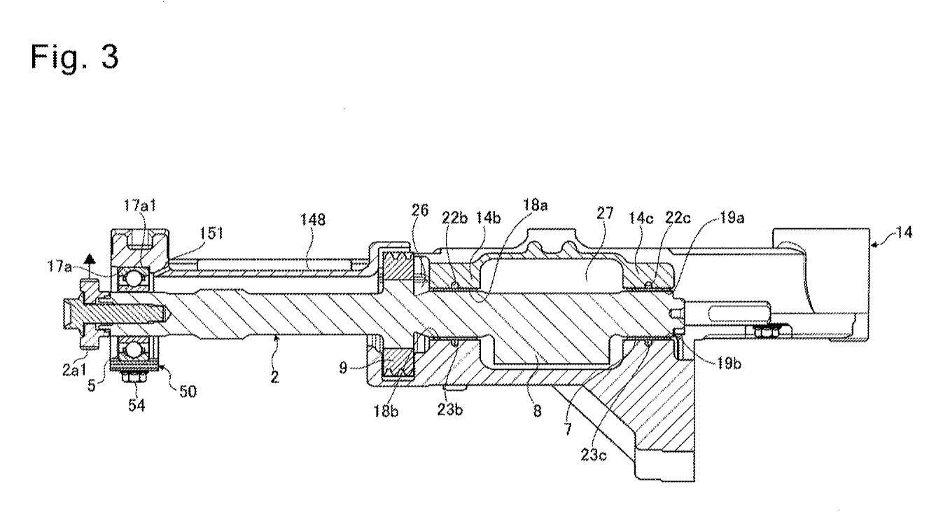

FIG. 1 is an exploded perspective view of a balancer device according to an Embodiment 1. FIG. 2 is a plan view of the balancer device according to the Embodiment 1. FIG. 3 is a cross-sectional view taken along line A-A of FIG. 2.

A balancer device 1 of the Embodiment 1 is housed in an oil pan, not shown, which is attached to a lower part of a cylinder block of an engine (internal combustion engine). The engine is, for example, a reciprocating engine of an inline-four type. The balancer device 1 includes a driving balancer shaft 2, a driven balancer shaft 3, and a housing 4. The driving balancer shaft 2 and the driven balancer shaft 3 are accommodated inside the housing 4. The driving balancer shaft 2 and the driven balancer shaft 3 are arranged parallel with each other so that axis directions of the driving and driven balancer shafts 2 and 3 are along a front to back direction of the engine. The invention will be described below on the premise that front to back, vertical, and transverse directions of the engine are represented by x-, y-, and z-axes, respectively, and also that a back-to-front direction of the engine is an x-axis positive direction; a bottom-to-top direction of the engine is a y-axis positive direction; and a left-to-right direction of the engine as viewed from the front side of the engine is a z-axis positive direction.

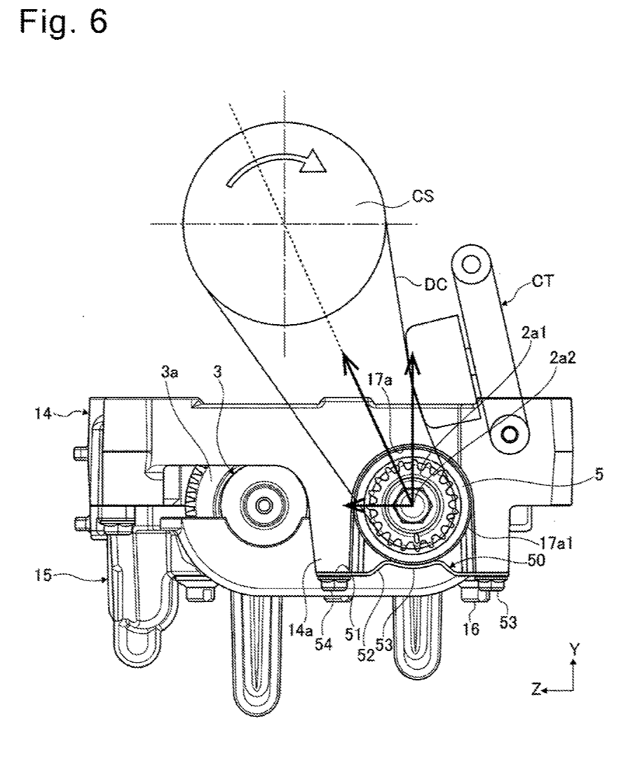

The driving balancer shaft 2 has an x-axis positive direction end 2a. A zeroth journal 2c is formed in the x-axis positive direction end 2a and engaged with a ball bearing 5. The driving balancer shaft 2 further has an x-axial center and an x-axis negative direction end 2b, which are provided with a first journal 2d and a second journal 2e, respectively. The first and second journals 2d and 2e each have a column-like shape. The zeroth journal 2c is supported against the housing 4 through the ball bearing 5 so as to be rotatable around the x-axis. The first and second journals 2d and 2e are supported against the housing 4 through slide bearings 6 and 7 so as to be rotatable around the x-axis. Each of the slide bearings 6 and 7 is half-split into two in the y-axis direction. Lubricant is supplied to the slide bearings 6 and 7 and slide bearings 10 and 11 from an oil supply aperture 149 extending between an oil pump and an upper housing 14 through a supply oil groove 23a formed only in a lower housing 15. Oil holes 6a and 7a for supplying lubricant are formed in x-axial centers of the slide bearings 6 and 7. A driving balancer weight 8 in a semicircular column-like shape is integrally provided with the driving balancer shaft 2 to be located between the first journal 2d and the second journal 2e in the x-axis direction. A balancer driving gear 9 is integrally provided between the zeroth journal 2c and the first journal 2d in the x-axis direction by being press-fitted into the driving balancer shaft 2. The balancer driving gear 9 is a helical gear. A balancer sprocket 2a1 is fixed with a bolt 2a2 to the x-axis positive direction end 2a of the driving balancer shaft 2. Torque is transmitted from a crankshaft of the engine to the balancer sprocket 2a1 through a driving chain CS (see FIG. 6). A rotational speed ratio of the crankshaft to the driving balancer shaft 2 is 1 to 2.

The driven balancer shaft 3 is formed smaller in shaft length than the driving balancer shaft 2. First and second journals 3c and 3d in a column-like shape are formed near an x-axis positive direction end 3a and at an x-axis negative direction end 3b of the driven balancer shaft 3. The first and second journals 3c and 3d are supported against the housing 4 through the cylindrical slide bearings 10 and 11 so as to be rotatable around the x-axis. The slide bearings 10 and 11 are formed by being half-split into two in the y-axis direction. Oil holes 10a and 11a for supplying lubricant are formed in x-axial centers of the slide bearings 10 and 11. The first journal 3c and the second journal 3d are disposed in corresponding positions in the x-axis direction as the first journal 2d and the second journal 2e of the driving balancer shaft 2. A driven balancer weight 12 having a semicircular column-like shape is integrally provided with the driven balancer shaft 3 so as to be located between the first journal 3c. and the second journal 3d in the x-axis direction. The driven balancer weight 12 is disposed to face the driving balancer weight 8 in the z-axis direction. A balancer driven gear 13 is press-fitted in the driven balancer shaft 3 and thus integrally provided at the x-axis positive direction end 3a of the driven balancer shaft 3. The balancer driven gear 13 is a helical gear engaged with the balancer driving gear 9. The balancer driving gear 9 and the balancer driven gear 13 have the same number of teeth. An oil pump driving shaft 3e is integrally provided at the x-axis negative direction end 3b of the driven balancer shaft 3. The oil pump driving shaft 3e drives an oil pump O/P. When the driven balancer shaft 3 rotates, the oil pump O/P is driven to supply lubricant.

The housing 4 includes the upper housing 14 and the lower housing 15. The housings 14 and 15 together have a shape divided into top and bottom halves in a substantially half-split manner at a plane parallel with a flat plane defined by the x- and z-axes. The housings 14 and 15 are fastened to a lower part of a cylinder block by a plurality of bolts 16 so as to lie on top of each other. The upper housing 14 and the lower housing 15 are provided with bearing projections 14a, 14b, 14c, 15b, and 15c extending in the y-axis direction. Formed in the bearing projection 14a of the upper housing 14 is an inverted arc-shaped bearing groove 17a fitted with an upper part of the ball bearing 5. Formed in the bearing projections 14b and 14c located on the driving balancer shaft 2 side of the upper housing 14 are semi arc-shaped bearing grooves 18a and 19a fitted with upper parts of the slide bearings 6 and 7. Similar bearing grooves are also formed on the driven balancer shaft 3 side of the upper housing 14. In the bearing grooves 18a and 19a on the driving balancer shaft 2 of the upper housing 14, there are formed oil grooves 22b and 22c extending in the y-axis direction. Bearing grooves 18b, 19b, 20b and 21b, each having a semi arc-like shape, are formed in the bearing projections 15b and 15c of the lower housing 15. The bearing grooves 18b, 19b, 20b and 21b are fitted with lower parts of the slide bearings 6, 7, 10 and 11. In the bearing grooves 18b, 19b, 20b and 21b, there are formed oil grooves 23b, 23c, 23d and 23e extending in the y-axis direction. The oil grooves 23b, 23c, 23d and 23e, together with the oil grooves 22b and 22c of the upper housing 14, form a tubular oil groove surrounding the slide bearings 6, 7, 10 and 11. The oil grooves 22b, 22c, 23b and 23c are located in positions coinciding with the oil holes 6a, 7a, 10a and 11a of the slide bearings 6, 7, 10 and 11, that is, at the x-axial centers of the slide bearings 6, 7, 10 and 11.

The upper housing 14 has an upper surface (engine-side surface) provided with first bosses 140a, second bosses 140b, and third bosses 140c for mounting on the engine, which are arranged in the order named from the x-axis positive direction side. The bearing projection 14a and the bearing groove 17a are formed in a lower surface side of the first bosses 140a. The second bosses 140b are disposed near a weight receiving projection 147 which receives the driving balancer weight 8 and the driven balancer weight 12. The third bosses 140c are disposed closer to the x-axis negative direction side than the driving balancer shaft 2 and the driven balancer shaft 3 are. The upper housing 14 has the upper surface provided with gear receiving projections 146 by which the balancer driving gear 9 and the balancer driven gear 13 are received. The gear receiving projections 146 are located between the first bosses 140a and the second bosses 140b in the x-axis direction. The upper housing 14 includes a through-aperture 145 and an enclosing rib 143 disposed in an upright manner so as to enclose an outer periphery of the through-aperture 145. The through-aperture 145 and the enclosing rib 143 are located in a region extending from the first bosses 140a to the gear receiving projections 146 and arranged closer to the driven balancer shaft 3 side than to the driving balancer shaft 2 as viewed from the y-axis direction. The above-described configuration reduces weight of the upper housing 14 and provide strength to a portion around the through-aperture 145.

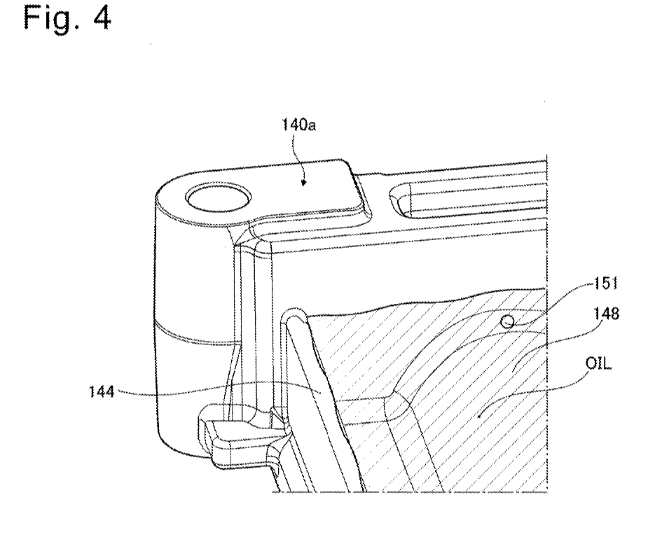

Ribs 142 and 144 are formed in an outer periphery of the upper housing 14. The ribs 142 and 144 connect the gear receiving projection 146 to the first bosses 140a. The ribs 142 and 144 secure housing strength of a region extending from the first bosses 140a to the second bosses 140b. A lubricant reservoir OIL for storing lubricant is formed in a section (section enclosed by dot-line in FIG. 2) which is surrounded by side walls 141 of the first bosses 140a, side walls 146 of the gear receiving projections 146, and the ribs 142 and 144, and partitioned by the enclosing rib 143. In the upper housing 14, there is formed a semi-cylindrical shaft receiving projection 148 which receives the driving balancer shaft 2. A lubricant supply passage 151 is formed near a connection between the shaft receiving projection 148 and the first bosses 140a, The lubricant supply passage 151 extends through to the bearing groove 17a in which the ball bearing 5 is received. FIG. 4 is an enlarged perspective view showing the first boss and the vicinity of the first boss according to the Embodiment 1. In FIG. 4, the stored lubricant is shown with hatching. The oil stored in the lubricant reservoir OIL is supplied through the lubricant supply passage 151 to the ball bearing 5.

Gear housing chambers 26 are disposed in the gear receiving projections 146 to be located inside the housing 4. In the gear housing chambers 26, the balancer driving gear 9 and the balancer driven gear 13 are accommodated to be rotatable around the x-axis. X-axial positions of the driving balancer shaft 2 and the driven balancer shaft 3 are determined by x-axial length of the balancer driving gear 9 and of the balancer driven gear 13, which are accommodated in the gear housing chamber 26 of the lower housing 15, and proper x-axial clearance extending from the gear housing chamber 26 to the balance driving gear 9 and the balancer driven gear 13. In the lower housing 15, an X-axis positive direction side of the gear housing chamber 26 is in communication with the outside of the housing 4. While the engine is in operation, a lower part of the lower housing 15 is soaked in oil contained in the oil pan. An oil level within the oil pan is set to such height that the oil does not enter the gear housing chamber 26. The lubricant is thus retained by the lubricant reservoir formed in the upper housing 14.

Weight housing chambers 27 are disposed in the weight receiving projections 147 to be located inside the housing 4. The driving balancer weight 8 and the driven balancer weight 12 are accommodated in the weight housing chambers 27 to be rotatable around the x-axis.

[Control of Secondary Vibration of the Engine]

According to the balancer device 1 of the Embodiment 1, when the crankshaft is rotationally driven in response to the engine start-up, the driving balancer shaft 2 rotates through the balancer sprocket twice as fast as the crankshaft. The driven balancer shaft 3 rotates in an opposite direction and at equal speed to the driven balancer shaft 2 through transmission of meshing rotation of the balancer driving gear 9 and the balancer driven gear 13. This causes the driving balancer weight 8 and the driven balancer weight 12 to rotate in an opposite direction to each other, cancelling out right and left centrifugal forces of the driving balancer shaft 2 and the driven balancer shaft 3 themselves. The driving balancer weight 8 and the driven balancer weight 12 rotate along with the rotation of the driving balancer shaft 2 and that of the driven balancer shaft 3 as described above to transmit a vibratory force to the engine, which makes it possible to control secondary vibration of the engine.

[Lubrication of Bearings and Gears]

When the engine starts, an oil pump serving as an auxiliary device of the engine is driven. The oil pump sucks the oil in the oil pan, and then pressurizes and discharges the oil. The oil discharged from the oil pump is distributed to the oil grooves 22b, 22c, 23b, 23c, 23d and 23e as lubricant for lubricating sliding parts of the balancer device 1. The oil then flows through the oil holes 6a, 7a, 10a and 11a of the slide bearings 6, 7, 10 and 11 into clearances between inner peripheries of the slide bearings 6, 7, 10 and 11 and outer peripheries of the journals 2d, 2e, 3c and 3d. The ball bearing 5 is not forcibly supplied with oil by the oil pump. The oil drops through a gap around the engine crankshaft's bearing into the lubricant reservoir 148 and then flows through the lubricant supply passage 151 to be supplied to the ball bearing 5. The ball bearing 5 is thus lubricated, and the slide bearings 6, 7, 10 and 11 are also lubricated on the journals 2d, 2e, 3c and 3d. The oil which has flown away from the slide bearings 6 and 10 toward the x-axis positive direction enters the gear housing chamber 26. The oil is then used for lubrication between the balancer driving gear 9 and the balancer driven gear 13. The oil is subsequently scraped up and scattered to be discharged from the x-axis positive direction side of the gear housing chamber 26 to the outside of the housing 4. The discharged oil is returned to the oil pan.

(Detail of the Zeroth Journal)

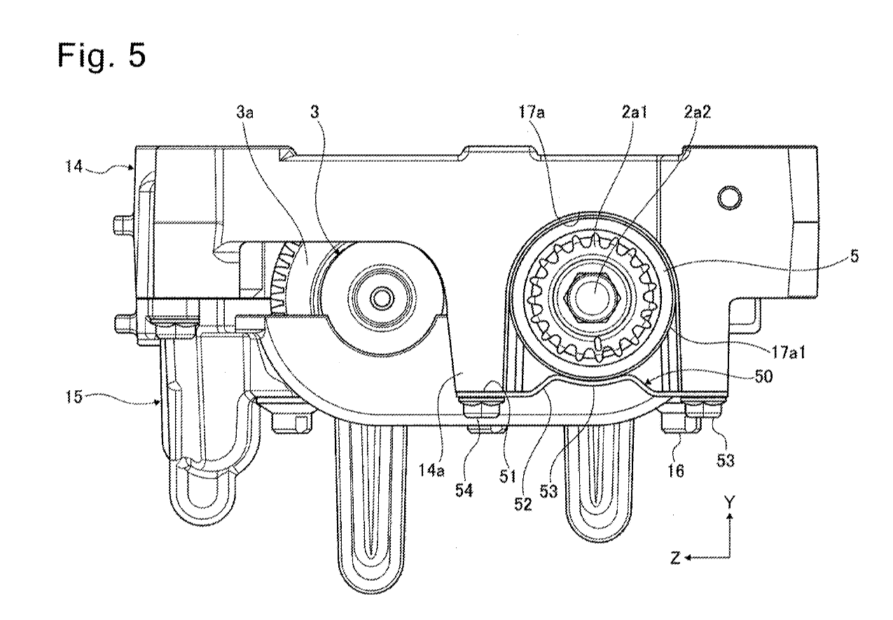

The following is a detail of the zeroth journal 2c which supports the ball hearing 5. FIG. 5 is a side view of the balancer device according to the Embodiment 1. The zeroth journal 2c is rotatably supported through the ball bearing 5. The ball bearing 5 is received in the bearing groove 17a. formed in the upper housing 14. The bearing groove 17a includes a stepped portion 17a1 which is formed by reducing a diameter the bearing groove 17a in a radial direction of the ball bearing 5. The stepped portion 17a1 determines an axial position of the ball bearing 5.

The bearing projection 14a comprises two bearing projections 14a arranged to hold the ball bearing 5 at both radial sides of the ball bearing 5. The two bearing projections 14a extend below a lowest edge of the ball bearing 5. The bearing projections 14a have lower edges attached with a retaining member 50 which holds the ball bearing 5 from underneath. Since the bearing projections 14a extend below the lowest edge of the ball bearing 5 as mentioned, the ball bearing 5 can be biased by the retaining member 50 without greatly bending the retaining member 50 in a downward direction. The retaining member 50 therefore has a compact shape and yet is capable of exerting a stable elastic force.

The retaining member 50 includes flanges 51 attached to lower end surfaces of the bearing projections 14a with bolts 54, bent portions 52 bent from the flanges 51 toward the engine, and a curved retaining portion 53 extends from the bent portion 52 in a curved way along a shape of an outer periphery of the ball bearing 5. The retaining member 50 is symmetric across the y-axis with the curved retaining portion 53 at the center. The retaining member 50 is produced by press-forming a ferrous metal and elastically holds the ball bearing 5 from underneath toward the bearing groove 17a (upper housing 14). The retaining member 50 may be made of any material as long as the material has elasticity. The retaining member 50 may be made of, for example, a sheet metal or a resin material, that is, an elastic body. When the retaining member 50 is made of resin material, the retaining member 50 can be inexpensively produced by pressing or injection forming.

The following explains a reason that the zeroth journal 2c is rotatably supported by the ball bearing 5, instead of a slide bearing. FIG. 6 is a schematic diagram showing relationship between the driving chain and the balancer device according to the Embodiment 1. A driving force of a crank sprocket CS which rotates integrally with the crankshaft is transmitted through the driving chain DC to the balancer sprocket 2a1. The driving chain DC is pressed by a chain tensioner CT and thus secures tension of the chain. At this time, the balancer sprocket 2a1 is applied with a force pulling the balancer sprocket 2a1 upward to the crankshaft side as shown by a thick line in FIG. 6. This produces a force acting to pull up the driving balancer shaft 2 toward the engine.

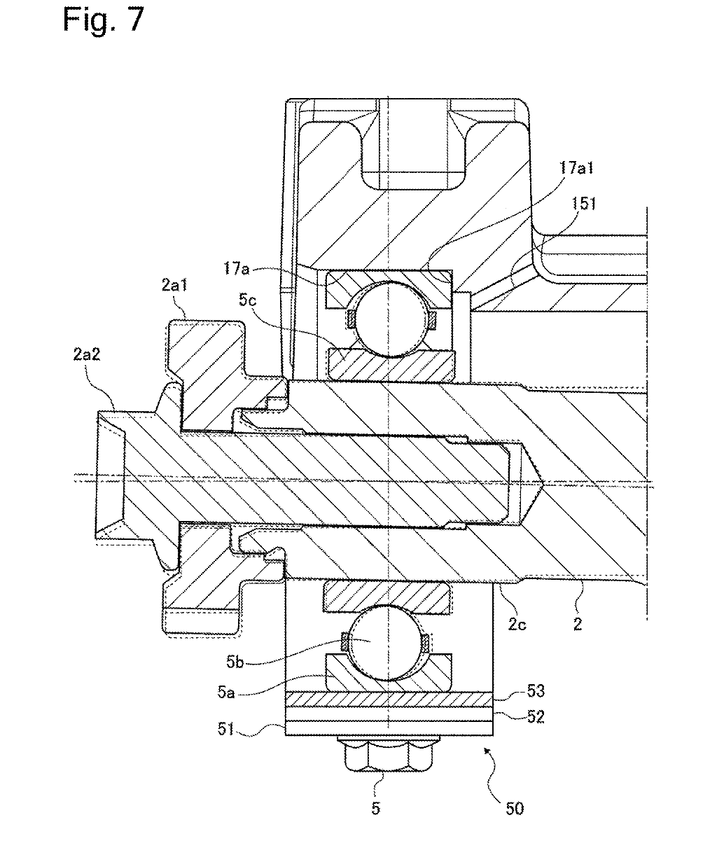

FIG. 7 shows a deformed state of the driving balancer shaft being pulled up toward the engine. Dot-lines in FIG. 7 outline the driving balancer shaft 2 before deformation, and solid lines outline the driving balancer shaft 2 after deformation. When deformed by the force pulling up the driving balancer shaft 2 toward the crankshaft, the driving balancer shaft 2 is pressed toward the upper housing 14. If a slide bearing, instead of the ball bearing 5, is disposed, an excess force acts only on an upper housing side of the slide bearing. Moreover, an end portion of the driving balancer shaft 2 is pulled upward, so that an area of the zeroth journal 2c, which is closer to the balancer sprocket 2a1, comes into tighter contact with the slide bearing. The slide bearing is therefore abraded in an uneven manner. The slide bearing is generally polished to extremely high smoothness in terms of surface roughness. The zeroth journal 2c has higher surface roughness than the slide bearing. Entry of contaminants and the like also increase the surface roughness of the slide bearing and of the journal 2c along with abrasion, thereby increasing friction.

According to the Embodiment 1, in contrast, the ball bearing 5 is disposed. Even if the deformation of the driving balancer shaft 2 inclines an inner race 5c of the ball bearing 5 relative to a rotation axis, an outer race 5a is not inclined since balls 5b move (hereinafter, this mechanism will be referred to as self-aligning mechanism). Even if the driving balancer Shaft 2 is deformed, the self-aligning mechanism makes it possible to avoid a friction increase without causing uneven abrasion.

The following description discusses an issue on the installation of the ball bearing 5. The ball bearing 5 is made of a ferrous metal, whereas the housing 4 comprising the upper and lower housings 14 and 15 is made of an aluminum metal. This means that the installation of the ball bearing 5 requires the components with different thermal expansion coefficients to be assembled together. The balancer device 1 is a device disposed close to the engine and is therefore likely to be affected by heat. If the balancer device 1 is heated, the housing 4 made of the aluminum metal is easier to expand, as compared to the ball bearing 5 made of the ferrous metal. When a portion of the housing 4, which receives the ball bearing 5, is increased in diameter as a result of thermal expansion, an increased amount of the diameter of the portion is larger than an increased amount of an external diameter of the ball bearing 5. This makes it difficult to stably support the ball bearing 5 using the housing 4.

To solve the above issue, it is necessary to provide the ball bearing 5 with a large interference to prevent a gap from being created during the thermal expansion, and moreover after deterioration (including dispersion of tolerance, creep in AL alloy, and permanent deformation). However, since the upper and lower housings 14 and 15 are made of the same aluminum metal and are the members assembled together with the bolts 16, the upper and lower housing 14 and 15 have to be fitted to each other with a great force. This might deform the ball bearing 5 to cause poor rotation. At the same time, it is necessary to secure the strength of the bolts 16, which creates a need to utilize thick bolts. In association with the securement of strength of the bolts 16, housing strength which is sufficient enough to bear a great axial force is also required on the housing 4 side. This raises the problem that the device is increased in size and weight.

As to the retaining of the ball bearing 5 in the Embodiment 1, the ball bearing 5 is held by the retaining member 50 which elastically holds the ball bearing 5 from underneath toward the upper housing 14. As already mentioned, the driving balancer shaft 2 is applied with the force pulling up the driving balancer shaft 2 toward the crankshaft, and is not applied with a great force acting downward. Even if the upper housing 14 is expanded and deteriorated as the result of thermal expansion, the ball bearing 5 is constantly biased, pressed or supported toward the upper housing 14 by the retaining member 50 with a proper elastic force. The ball bearing 5 therefore can be stably held, supported or fixed. Since the bail bearing 5 is elastically held, supported or fixed, there is no need to apply a great force to the bolts 54 for fastening the retaining member 50 to the upper housing 14. This makes it possible to avoid an increase in size of the bearing projections 14a and downsize the balancer device 1.

As explained above, the Embodiment 1 provides the following operation and advantageous effects.

(1) The balancer device 1 comprises the driving balancer shaft 2 (driving shaft) provided with the driving balancer weight 8 (first balancer weight) at one axial end and provided with the balancer sprocket 2a1 (driven rotor) at the other axial end, the balancer sprocket 2a1 being rotated by the rotation of the crankshaft being transmitted thereto through the driving chain CS (endless transmission member); the driven balancer shaft 3 (driven shaft) including the driven balancer weight 12 (second balancer weight) in the position corresponding to the driving balancer weight 8, the driven balancer shaft 3 being rotationally driven in the opposite direction to the rotation of the driving balancer shaft 2; the upper housing 14 configured to rotatably support upper half portions of both end portions of the balancer weights 8 and 12 of the driving and driven balancer shafts 2 and 3; and the lower housing 15 assembled with the upper housing 14 and configured to rotatably support lower half portions of both the end portions. The balancer device 1 includes the ball bearing 5 (rolling bearing) disposed adjacently to the balancer sprocket 2a1 and configured to rotatably support the driving balancer shaft 2; the bearing groove 17a (bearing receiving portion) disposed in the upper housing 14 to be located in the position corresponding to the ball bearing 5, the bearing groove 17a being configured to receive an upper half portion of the bail bearing 5; and the retaining member 50 (first member) disposed correspondingly to the bearing groove 17a and configured to bias the ball bearing 5 toward the bearing groove 17a (upper housing 14).

It is therefore possible to reduce rotational resistance of the driving balancer shaft 2. In addition, since the rolling bearing is biased, it is not necessary to hold the rolling bearing with a proper fixing force, which makes it possible to downsize the balancer device.

(2) The upper housing 14 includes the lubricant supply passage 151 (communication aperture) configured to bring the upper surface side and a lower surface side of the upper housing 14 into communication with each other.

It is therefore possible to supply the lubricant from the upper surface of the upper housing 14 toward the rotors including the ball bearing 5.

(3) The lubricant reservoir OIL is disposed on the upper surface of the upper housing 14, the lubricant reservoir OIL being in communication with the lubricant supply passage 151 and capable of storing lubricant.

It is therefore possible to store the lubricant which has dropped from the engine side, which enables lubrication to be stably supplied to the ball bearing 5 when the engine is restarted after being stopped and left for a long period of time.

(4) The lubricant reservoir OIL comprises the ribs 142, 143 and 144 formed in the upper surface of the upper housing 14.

It is therefore possible to secure the strength of the upper housing 14 and store the lubricant at the same time.

(5) The retaining member 50 is formed of the elastic body. The ball bearing 5 therefore can be held in a stable manner.

(6) The retaining member 50 is made of resin material. It is therefore possible to inexpensively and easily produce the retaining member 50.

(7) The retaining member 50 is formed by pressing. This makes it easy to form the retaining member 50.

(8) The retaining member 50 includes the stepped portion 17a1 (engaging portion) configured to prevent the ball bearing 5 from moving in an axial direction of the driving balancer shaft 2.

This facilitates the axial positioning of the ball bearing 5.

(9) The ball bearing 5 includes the outer race 5a in contact with the bearing groove 17a, the inner race 5c through which the driving balancer shaft 2 extends, and the balls 5b (spherical rolling elements) arranged between the outer race 5a. and the inner race 5c.

The driving balancer shaft 2 therefore can be held in a stable manner due to the self-aligning mechanism even if inclined after deformation or the like.

(10) The hearing groove 17a includes a semicircular portion configured to receive the upper half portion of the ball bearing 5, and the bearing projections 14a which are straight portions extending from both sides of the semicircular portion toward the retaining member 50. The retaining member 50 is disposed at the lower edges of the bearing projections 14a.

The straight portions make it possible to bias the ball bearing 5 from underneath without greatly bending the retaining member 50 and apply a small, stable elastic force to the ball bearing 5.

### Embodiment 2

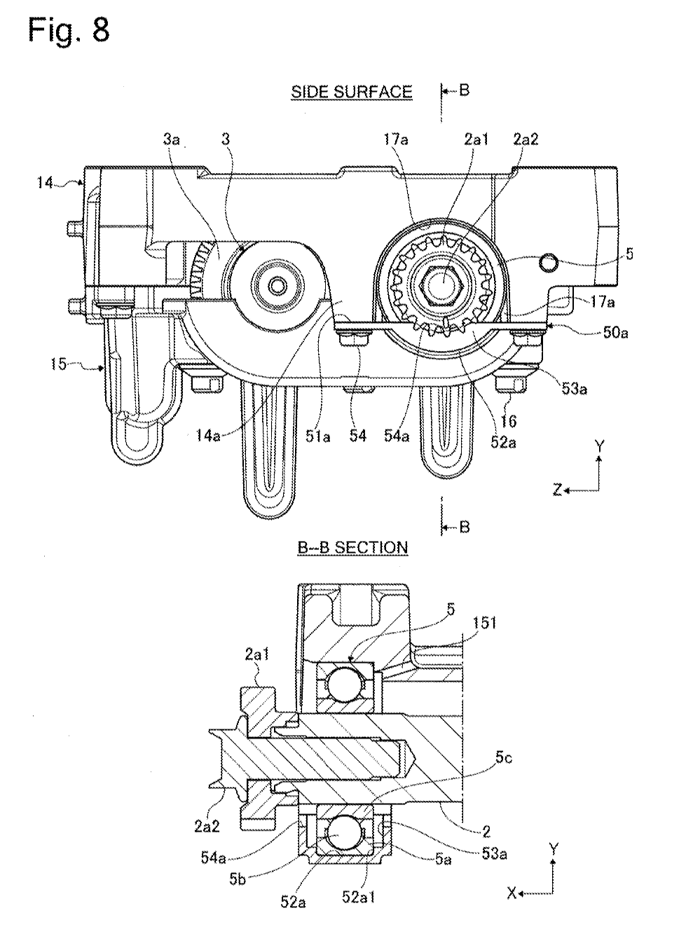

An Embodiment 2 will now be described. As the Embodiment 2 is similar in basic configuration to the Embodiment 1, the following description discusses differences from the Embodiment 1. FIG. 8 shows a side view and a cross-sectional view of a balancer device according to the Embodiment 2, taken along line B-B. A retaining member 50a is attached to lower edges of the bearing projections 14a. The retaining member 50a holds a ball bearing 5 from underneath. The retaining member 50a includes flanges 51a attached to lower end surfaces of the bearing projections 14a with bolts 54; a curved retaining portion 52a which extends from each of the flanges 51a in a curved way in the opposite direction to an engine along a shape of an outer periphery of the ball bearing 5; stepped portions 52a1 formed along side surfaces of an outer race 5a of the ball bearing 5 in a standing manner on x-axial front and rear sides of the curved retaining portion 52a, the stepped portions 52a1 being configured to determine an axial position of the ball bearing 5; side plates 53a disposed in a standing manner in positions away from the stepped portion 52a1 in an axial direction of a driving balancer shaft 2 and also away from the ball bearing 5; and arc-like cutaway portions 54a formed in the engine side of the side plates 53a. The retaining member 50a is symmetric across a y-axis with the curved retaining portion 52a at the center. The retaining member 50a is produced by press-forming a ferrous metal and elastically holds the ball bearing 5 from underneath toward an upper housing 14. The retaining member 50a may be made of resin material which is an elastic body. Use of resin material makes it possible to produce the retaining member 50a inexpensively and easily.

The side plates 53a formed in both sides of the curved retaining portion 52a have upper edges arranged at substantially the same level as the flanges 51a. Levels of the upper edges are so determined that the upper edges are located between the outer race 5a and the inner race 5c as viewed on a virtual line touching a lowest edge of the ball bearing 5 and extending through the center of the driving balancer shaft 2. There is a small clearance between each of the side plates 53a and the ball bearing 5. The clearance functions as a reservoir for storing lubricant. However, too much lubricant increases stirring resistance which is caused during the rotation of the ball bearing 5. To solve this problem, each of the side plates 53a is provided with the cutaway portion 54a. The upper edge of each of the side plates 53a, which is located near the above-mentioned virtual line, is cut in an arc-like shape. A lowest end portion of the cutaway portion 54a, as viewed on the virtual line, is located higher than an upper edge of the outer race 5a and lower than a lower edge of the inner race 5c. This prevents the lubricant from exceeding a cutout's lowest end portion of the cutaway portion 54, enabling the ball bearing 5 to be lubricated with a proper amount of lubricant.

As explained above, the Embodiment 2 provides the following operation and advantageous effects.

(11) The retaining member 50a includes the reservoir capable of storing lubricant. The reservoir is located between the retaining member 50a and the ball bearing 5 relative to the axial direction of the driving balancer shaft 2.

The ball bearing 5 therefore can be lubricated in a stable manner.

(12) The retaining member 50a is formed by bending a sheet metal. This facilitates production of the retaining member 50a.

(13) The retaining member 50a includes the stepped portion 52a1 (engaging portion) configured to prevent the ball bearing 5 from moving in the axial direction of the driving balancer shaft 2.

This facilitates the axial positioning of the ball bearing 5.

(14) The ball bearing 5 includes the outer race 5a in contact with a bearing groove 17a, the inner race 5c through which the driving balancer shaft 2 extends, and balls 5b arranged between the outer race 5a and the inner race 5c. The retaining member 50a includes the arc-shaped cutaway 54a between the inner race 5c and the outer race 5a.

It is therefore possible to avoid the stirring resistance caused by an excess amount of lubricant and attain stable lubrication.

### Embodiment 3

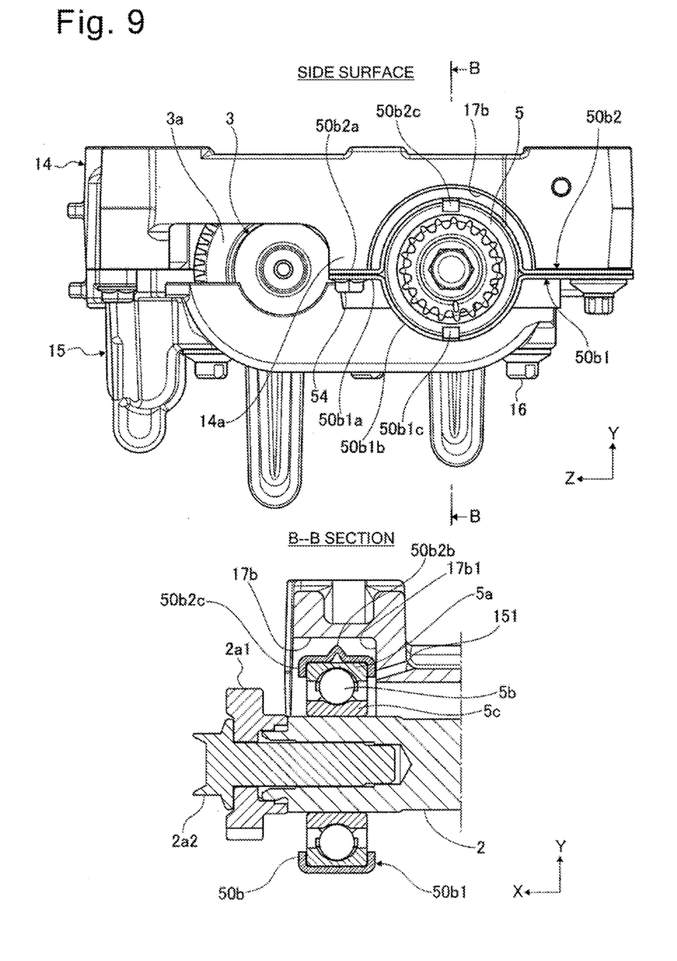

The following description explains an Embodiment 3. As the Embodiment 3 is similar in basic configuration to the Embodiment 1, the following description discusses differences from the Embodiment 1. FIG. 9 shows a side view and a cross-sectional view of a balancer device according to the Embodiment 3, taken along line B-B. Attached to lower edges of bearing projections 14a are a lower retaining member 50b1 and an upper retaining member 50b2, which are configured to hold a ball bearing 5. The lower retaining member 50b1 is produced by press-forming a ferrous/light metal. The lower retaining member 50b1 includes flanges 50b1a fastened to lower end surfaces of the bearing projections 14a with bolts 54; a curved retaining portion 50b1b curved along a shape of an outer periphery of the ball bearing 5; and claw portions 50b1c formed in both axial sides at a substantially center of the curved retaining portion 50b1b, the claw portions 50b1c being configured to determine an axial position of the bail bearing 5. The claw portion 50b1c is also applicable to the retaining member 50 in another shape. The upper retaining member 50b2 is produced by press-forming a ferrous/light metal. The upper retaining member 50b2 includes flanges 50b2a fastened to lower end surfaces of bearing projections 14a with a bolt 54; a curved retaining portion 50b2b curved along a shape of an outer periphery of the bail bearing 5 and having a rib in a substantially center of the driving balancer shaft 2 in an axial direction; and claw portions 50b2c formed in both axial sides at a substantially center of the curved retaining portion 50b2b, the claw portions 50b2c being configured to determine an axial position of the ball bearing 5. The lower retaining member 50b1 and the upper retaining member 50b2 are jointly fastened with the bolt 54 which is common therebetween.

The bearing groove 17b is formed larger in size than an outermost periphery of the curved retaining member 50b2b provided with the rib. The upper retaining member 50b2 is firmly prevented by the rib from being elastically deformed, whereas the lower retaining member 50b1 is not provided with a rib or the like and thus elastically deformable as compared to the upper retaining member 50b2. The curved retaining portion 50b1b of the lower retaining member 50b1 has such a shape as to cover a circumferential area which is slightly smaller than other circumferential areas except a circumferential area in which the outer periphery of the ball bearing 5 is covered with the curved retaining portion 50b2b of the upper retaining member 50b2. Fastening of the lower retaining member 50b1 with the bolt 54 therefore brings the flanges 50b1 a and the curved retaining portion 50b1b into elastic deformation, and the flanges 50b1a and the curved retaining portion 50b1b elastically hold the ball bearing 5 while biasing the ball bearing 5 toward the upper housing 14.

As explained above, the Embodiment 3 provides the following operation and advantageous effects.

(15) The lower retaining member 50b1 and the upper retaining member 50b2 include the claw portions 50b1c and 50b2c which hold an outer race 5a of the ball bearing 5.

An axial position of the ball bearing 5 therefore can be stably maintained.

(16) The ball bearing 5 is held by the upper retaining member 50b2.

Machining accuracy is not much required in forming the bearing groove 17b in the upper housing 14, which enables the upper housing 14 to be produced inexpensively.

### Embodiment 4

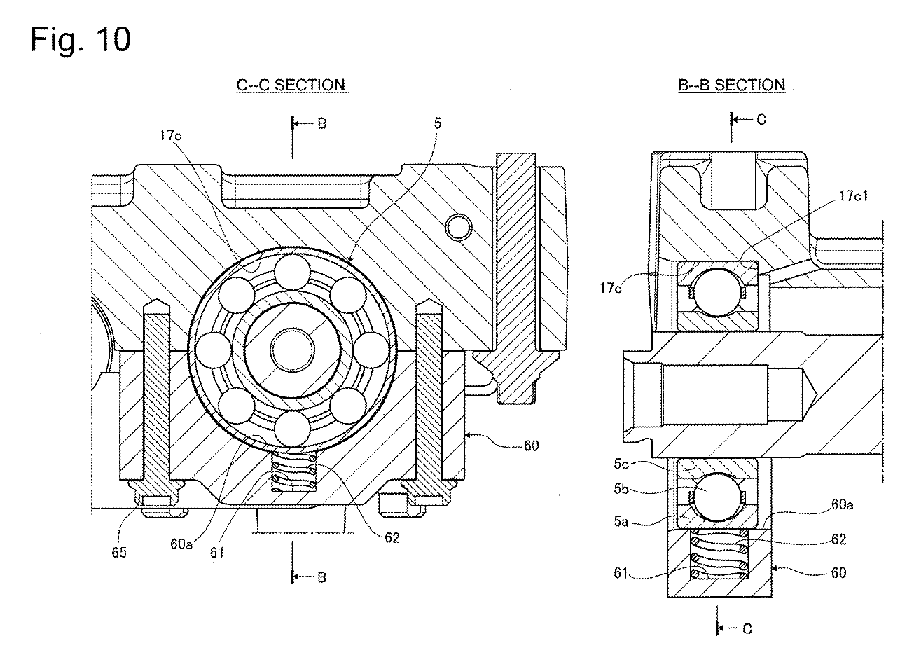

An Embodiment 4 will now be described. As the Embodiment 4 is similar in basic configuration to the Embodiment 1, the following description discusses differences from the Embodiment 1. FIG. 10 shows cross-sectional views of a balancer device according to the Embodiment 4, taken along lines C-C and B-B. According to the Embodiment 1, the ball bearing 5 is elastically held by the retaining member 50. Unlike the Embodiment 1, the Embodiment 4 includes a second lower housing 60 made of an aluminum metal. The second lower housing 60 has a semicircular housing portion 60a which accommodates a ball. bearing 5, and an elastic body housing portion 61 which is formed in a lower end of the housing portion 60a and accommodates a coil spring 62 in the inside. The second lower housing 60 is integrally assembled with an upper housing 14 using bolts 65. At the time of the assembly, a substantially circular space is formed by a hearing groove 17c of the upper housing 14 and the housing portion 60a of the second lower housing 60. The space is slightly larger than an outer shape of the ball bearing 5 and allows the ball bearing 5 to move in a y-axis direction. The space eliminates the need of press-fit fixation or the like for the ball bearing 5 at the time of assembly of the upper housing 14 and the second lower housing 60. Consequently, it is not required that the bolts 65 have much strength, so that the housings do not have to be increased in size. The coil spring 62 biases the ball bearing 5 toward the upper housing 14, which enables the ball hearing 5 to be elastically supported.

As explained above, the Embodiment 4 provides the following operation and advantageous effects.

(17) The second lower housing 60 includes the coil spring 62 (elastic, member) configured to press the ball bearing 5, and the elastic member housing portion 61 in which the coil spring 62 is accommodated.

It is therefore possible to elastically hold the ball bearing 5.

(18) The elastic member is a coil spring. The elastic member therefore can apply a stable elastic force even if a deformed amount of a driving balancer shall 2 is large.

### Embodiment 5

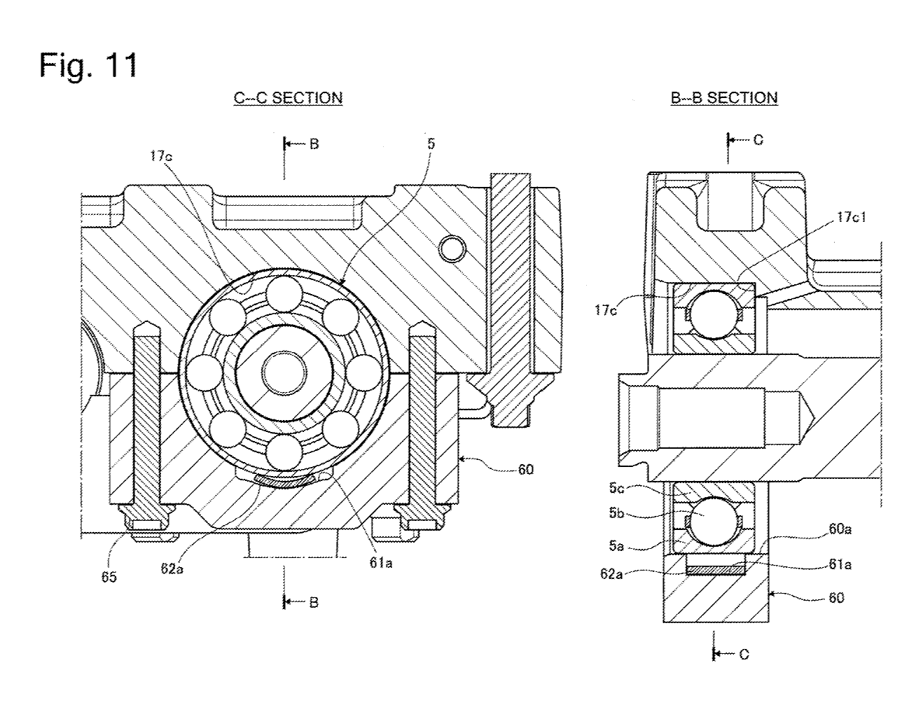

An Embodiment 5 will be explained below. As the Embodiment 5 is similar in basic configuration to the Embodiment 4, the following description discusses differences from the Embodiment 4. FIG. 11 shows cross-sectional views of a balancer device according to the Embodiment 5, taken along lines C-C and B-B. The Embodiment 4 uses the coil spring 62 as the elastic member, whereas the Embodiment 5 uses a leaf spring 62a as the elastic member. The leaf spring 62a arched downward is accommodated in a housing portion 61a of a second lower housing 60. This provides similar operation and advantageous effects to those of the Embodiment 4. The leaf spring 62a is capable of producing a large elastic force within a very small deformed area, and therefore can be downsized as compared to coil springs.

As explained above, the Embodiment 5 provides the following operation and advantageous effects.

(19) The elastic member is the leaf spring 62a. It is therefore possible to obtain an elastic force within a very small deformed area and thus downsize the device.

### Embodiment 6

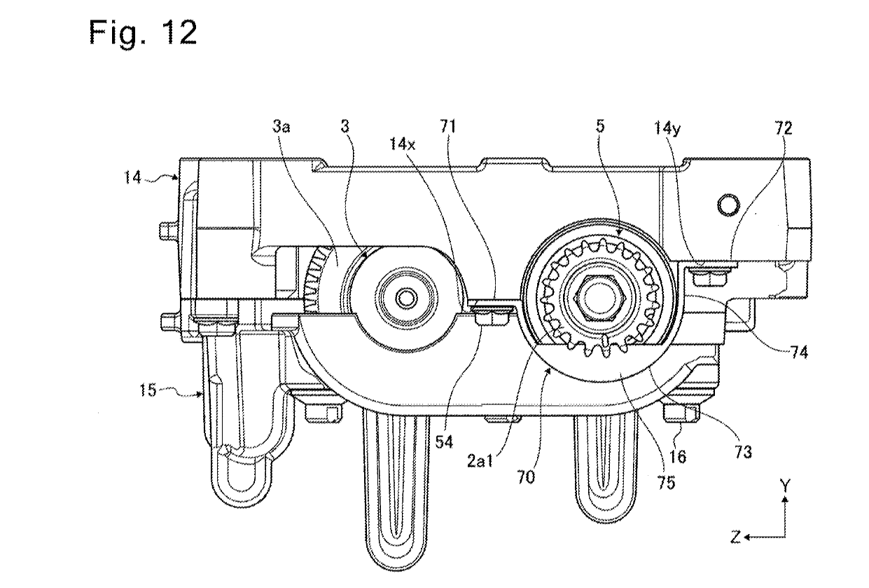

An Embodiment 6 will be described below. As the Embodiment 6 is similar basic configuration to the Embodiment 1, the following description discusses differences from the Embodiment 1. FIG. 12 is a side view of a balancer device according to the Embodiment 6. According to the Embodiment 1, the lower edges of the two bearing projections 14a are at substantially the same level. In the Embodiment 6, however, bearing projections are differentiated in level. A retaining member 70 includes a first flange 71 fixed to one bearing projection 14x; a second flange 72 fixed to a bearing projection 14y with a lower edge positioned above a lower edge of the one bearing projection; a curved retaining portion 73 which extends from the first flange 71 in a curved way in the opposite direction to an engine along a shape of an outer periphery of a ball bearing 5; a stretching portion 74 Which stretches from the curved retaining portion 73 toward the second flange 72 in a y-axis direction to be connected to the second flange 72; and a side panel 75 disposed in a standing manner in a position away from the ball bearing 5 in an axial direction of the driving balancer shaft 2. The retaining member 70 is asymmetric across the y-axis with the curved retaining portion 73 at the center. The retaining member 70 is produced by press-(burning a ferrous metal and elastically holds the ball bearing 5 from underneath toward an upper housing 14. Although the bearing projections 14x and 14y are different in lower edge positions as described, the ball bearing 5 can be elastically held by altering the shape of the retaining member 70. This results in an increase in freedom for designing the upper housing 14 and thus makes it possible to downsize the upper housing 14.

### Other Embodiments

The invention has been described on the basis of the Embodiments. The specific configuration of the invention is not limited to the ones mentioned in the Embodiments. Design modification and the like which do not deviate from the gist of the invention are included in the invention.

For example, the Embodiments show the cases where the ball bearings with balls are used as rolling bearings. However, roller bearings with columnar rolling elements can also provide similar operation and advantageous effects to those of the Embodiments.

The invention may have the following aspects.

According to one aspect, a balancer device comprises a driving shaft provided with a first balancer weight at one axial end and provided with a non-driving rotor at the other axial end, the non-driving rotor being rotated by rotation of a crankshaft being transmitted thereto through an endless transmission member; a driven shaft including a second balancer weight in a position corresponding to the balancer weight of the driving shaft, the driven balancer shaft being rotationally driven in an opposite direction to the rotation of the driving shaft; an upper housing configured to rotatably support upper half portions of both end portions of the balancer weights of the driving and driven shafts; and a lower housing assembled with the upper housing and configured to rotatably support lower half portions of both the end portions. The balancer device includes a rolling bearing disposed adjacently to the driven rotor and configured to rotatably support the driving shaft; a bearing receiving portion disposed in the upper housing to be located in a position corresponding to the rolling bearing, the bearing receiving portion being configured to receive an upper half portion of the rolling bearing; and a first member disposed correspondingly to the bearing receiving portion and configured to bias the rolling bearing toward the upper housing.

According to a preferred aspect, the upper housing includes a communication aperture configured to bring an upper surface side and a lower surface side of the upper housing into communication with each other.

According to another preferred aspect, a lubricant reservoir is disposed on an upper surface of the upper housing, the lubricant reservoir being in communication with the communication aperture and capable of storing lubricant.

According to still another preferred aspect, the lubricant reservoir comprises a rib formed in the upper surface of the upper housing.

According to still another preferred aspect, the first member includes a claw portion configured to hold an outer race of the rolling bearing.

According to still another preferred aspect, the first member is formed by pressing.

According to still another preferred aspect, the first member includes a reservoir capable of storing lubricant, the reservoir being located between the rolling bearing and the first member relative to an axial direction of the driving shaft.

According to still another preferred aspect, the first member is formed by bending a sheet metal,

According to still another preferred aspect, the first member includes an elastic member configured to press the rolling bearing, and an elastic member housing portion in which the elastic member is accommodated.

According to still another preferred aspect, the elastic member is a coil spring.

According to still another preferred aspect, the elastic member is a leaf spring.

According to still another preferred aspect, the first member includes an engaging portion configured to prevent the rolling bearing from moving in an axial direction of the driving shaft.

According to still another preferred aspect, the first member includes a reservoir capable of storing hydraulic fluid, the reservoir being located between the rolling bearing and the first member relative to the axial direction of the driving shaft.

According to still another preferred aspect, the rolling bearing includes an outer race in contact with the bearing receiving portion, an inner race through which the balancer shaft extends, and rolling elements arranged between the outer race and the inner race. The first member includes a cutaway portion on an arc between the inner race and the outer race.

According to still another preferred aspect, the rolling bearing includes an outer race in contact with the bearing receiving portion, an inner race through which the balancer shaft extends, and a spherical rolling element disposed between the outer race and the inner race.

According to still another preferred aspect, the rolling bearing includes an outer race in contact with the bearing receiving portion of the upper housing, an inner race through which the balancer shaft extends, and a columnar rolling element disposed between the outer race and the inner race.

According to still another preferred aspect, the bearing receiving portion includes a semicircular portion configured to receive an upper half portion of the rolling bearing, and straight portions extending from both sides of the semicircular portion to the first member side. The first member is disposed at lower edges of the straight portions.

In another light, a balancer device comprises a balancer shall including a balancer weight at one axial end; a driving rotor disposed at the other axial end of the balancer shaft and rotation of a drive source being transmitted thereto through an endless transmission member; a housing disposed on one side which is pulled by tension of the endless transmission member, located adjacently to the balancer weight, and including a bearing upper half portion which rotatably supports an upper half portion of the balancer shaft; a support member disposed on an opposite side to the one side, the support member being capable of rotatably supporting the balancer shaft when assembled with the bearing upper half portion; a bearing receiving portion formed in the housing adjacent to the driving rotor, the bearing receiving portion being released at the opposite side; a rolling bearing including an upper half portion received in the bearing receiving portion, the rolling bearing being configured to rotatably support the balancer shaft; and a securing member disposed on the opposite side and configured to secure the rolling bearing.

In still another light, a balancer device for an internal combustion engine comprises a housing attached to a lower part of an internal combustion engine, a sprocket driven with torque of the internal combustion engine through a chain; a plurality of bearings disposed inside the housing; a balancer shaft disposed inside the housing, including an outer periphery formed with journal surfaces which slide against bearing surfaces of the bearings to be rotatably supported, and configured to rotate integrally with the sprocket; a counterweight integrally formed in the balancer shaft and disposed between the bearings; a bearing receiving portion formed in the housing to be located in a position adjacent to the sprocket, the bearing receiving portion being pulled at one side by tension of the chain and released at an opposite side; a rolling bearing received in the bearing receiving portion and configured to rotatably support the balancer shaft; and a securing member disposed in the other side and configured to secure the rolling bearing.

The foregoing descriptions are related only to several embodiments of the invention. It should be easily understood by a person skilled in the art that the embodiments illustrated above may be modified or improved in various ways without substantial deviation from the new teachings and advantages of the invention. It is therefore intended that any embodiments added with such modification or improvement are included in the technical scope of the invention. The embodiments may be combined in any way.

The present application claims priority under Japanese Patent Application No. 2016-032403 filed on Feb. 23, 2016. The entire disclosure of Japanese Patent Application No. 2016-032403 filed on Feb. 23, 2016, including the description, claims, drawings and abstract, is incorporated herein by reference in its entirety.

### REFERENCE SIGNS LIST

1 Balancer device

2 Driving balancer shaft

3 Driven balancer shaft

4 Housing

5 Ball bearing

6, 7, 10, 11 Slide bearing

6a, 7a, 10a, 11a Oil hole

8 Driving balancer weight

12 Driven balancer weight

14 Upper housing

15 Lower housing

27 Weight housing chamber

50 Retaining member

1. A balancer device comprising:
a driving shaft including a first balancer weight at one axial end and a driven rotor at an opposite axial end, rotation of a crankshaft being transmitted to the driven rotor through an endless transmission member;
a driven shaft including a second balancer weight in a position opposite to the balancer weight of the driving shaft, the driven shaft being rotationally driven in an opposite direction to rotation of the driving shaft;
bearings disposed at both ends of the balancer weights of the driving and driven shafts and configured to support the driving and driven shafts;
an upper housing configured to accommodate the first and second balancer weights and support upper half portions of the bearings;
a lower housing assembled with the upper housing and configured to support lower half portions of the bearings;
a rolling hearing disposed adjacently to the driven rotor and configured to support the driving shaft;
a bearing receiving portion formed in the upper housing and configured to support an upper half portion of the rolling bearing; and
a retaining member fixed to the upper housing and configured to bias a lower half portion of the rolling bearing toward the bearing receiving portion.

2. The balancer device according to claim 1, wherein
the upper housing includes a communication aperture configured to bring an upper surface side of the upper housing and the bearing receiving portion located in a lower surface side of the upper housing into communication with each other.

3. The balancer device according to claim 2, wherein
an upper surface of the upper housing is provided with a lubricant reservoir, the lubricant reservoir in which the communication aperture opens and which is capable of storing lubricant.

4. The balancer device according to claim 3, wherein
the lubricant reservoir is surrounded by a rib formed in the upper surface of the upper housing.

5. The balancer device according to claim 1, wherein
the support member includes a claw portion configured to hold an outer race of the rolling bearing.

6. The balancer device according to claim 1, wherein
the support member is formed of an elastic body.

7. The balancer device according to claim 1, wherein
the support member includes a reservoir capable of supplying lubricant to a rolling element of the rolling hearing.

8. The balancer device according to claim 6, wherein
the support member is made of a sheet metal.

9. The balancer device according to claim 1, wherein
the support member includes an elastic member configured to bias the lower half portion of the rolling bearing toward the bearing receiving portion, and an elastic member housing portion in which the elastic member is accommodated.

10. The balancer device according to claim 9, wherein
the elastic member is a coil spring.

11. The balancer device according to claim 9, wherein
the elastic member is a leaf spring.

12. The balancer device according to claim 1, wherein
the support member includes an engaging portion configured to prevent the rolling bearing from moving in an axial direction of the driving shaft.

13. The balancer device according to claim 12, wherein
the rolling hearing includes an outer race in contact with the bearing receiving portion, an inner race through which the balancer shaft extends, and a rolling element disposed between the outer race and the inner race; and
the support member includes an arc-shaped cutaway portion between the inner race and the outer race.

14. The balancer device according to claim 1, wherein
the rolling bearing includes an outer race in contact with the bearing receiving portion, an inner race through which the balancer shaft extends, and a spherical rolling element disposed between the outer race and the inner race.

15. The balancer device according to claim 1, wherein
the rolling bearing includes an Outer race in contact with the bearing receiving portion of the upper housing, an inner race through which the balancer shaft extends, and a columnar rolling element disposed between the outer race and the inner race.

16. The balancer device according to claim 1, wherein
the bearing receiving portion of the upper housing includes a supporting portion configured to receive the upper half portion of the rolling bearing, and extending portions which extend from both sides of the supporting portion toward the lower housing; and
the support member is disposed at lower edges of the extending portions.

17. A balancer device comprising;
a balancer shaft including a balancer weight at one axial end;
a driven rotor disposed at the other axial end of the balancer shaft, rotation of a drive source being transmitted to the driven rotor through an endless transmission member;
a housing located adjacently to the balancer weight and provided with a bearing which is capable of rotatably supporting the balancer shaft;
a bearing receiving portion formed in the housing so as to be located in a position adjacent to the driven rotor correspondingly to the driven rotor, the bearing receiving portion being released at an opposite side to a side pulled by tension of the endless transmission member;
a rolling bearing including an upper half portion received in the bearing receiving portion, the rolling bearing being configured to rotatably support the balancer shaft; and
a retaining member disposed in the opposite side and configured to elastically press the rolling bearing toward the bearing receiving portion.

18. A balancer device for an internal combustion engine, comprising:
a housing attached to a lower part of an internal combustion engine;
a sprocket driven with rotation of the internal combustion engine through a chain;
a plurality of bearings disposed in the housing;
a balancer shaft accommodated in the housing, the balancer shaft being rotatably supported by journal surfaces formed in an outer periphery of the balancer shaft sliding against bearing surfaces of the bearings, and the balancer shaft being configured to rotate integrally with the sprocket;
a balancer weight integrally provided with the balancer shaft and disposed between the bearings;
a bearing receiving portion formed in the housing to be located in a position adjacent to the sprocket, the bearing receiving portion being pulled at one side by tension of the chain and released at the other side;
a rolling bearing received in the bearing receiving portion and configured to rotatably support the balancer shaft; and
a retaining member disposed in the other side and configured to elastically press the rolling bearing toward the bearing receiving portion.
